(19) United States
(12) Patent Application Publication
(10) Pub. No.: US 2024/0191749 A1
(43) Pub. Date: Jun. 13, 2024

(54) SLIDE RAIL DEVICE

(71) Applicant: Tsung-Yao CHEN, New Taipei City (TW)

(72) Inventor: Tsung-Yao CHEN, New Taipei City (TW)

(21) Appl. No.: 18/479,405

(22) Filed: Oct. 2, 2023

(30) Foreign Application Priority Data
Dec. 12, 2022 (TW) 111147641

(51) Int. Cl. F16C 29/02

(52) U.S. Cl. CPC F16C 29/02

(57) ABSTRACT

A slide rail device is adapted for collecting drill dust, and includes a fixed rail and a plurality of dust-collecting units. The fixed rail has a first surface and a second surface that are spaced apart from each other, a plurality of through holes that are formed through the first surface and the second surface, and a plurality of through-hole surfaces that respectively define the through holes. Each of the through-hole surfaces defines two openings that are respectively in the first surface and the second surface. Each of the dust-collecting units includes a cover member that closes one of the openings of a respective one of the through-hole surfaces, and a dust-catching member that is adapted for the drill dust to adhere thereto. The cover member of each of the dust-collecting units cooperates with the respective one of the through-hole surfaces to define a dust-collecting space.

### CROSS-REFERENCE TO RELATED APPLICATION

This application claims priority to Taiwanese Invention Patent Application No. 111147641, filed on Dec. 12, 2022, and incorporated by reference herein in its entirety.

### FIELD

The disclosure relates to a slide rail device, and more particularly to a slide rail device that is capable of collecting drill dust.

### BACKGROUND

Referring to FIGS. 1 to 3, a conventional slide rail device is adapted to be mounted between a cabinet body 12 and a drawer (not shown). The slide rail device includes a fixed rail 11, a moving rail 19, a linkage rail 18, and ball bearings 17. The fixed rail 11 is fixedly mounted to the cabinet body 12. The moving rail 19 is fixedly mounted to the drawer. The linkage rail 18 is slidably disposed between the fixed rail 11 and the moving rail 19. The ball bearings 17 are disposed among the fixed rail 11, the linkage rail 18, and the moving rail 19. Each of the ball bearing 17 includes a plurality of balls 171 that are rollable.

The fixed rail 11 has a plurality of through holes 111 that are spaced apart from each other. When installing the conventional slide rail device, a furniture installer may use a screwdriver or an electric screwdriver to urge a plurality of screws 13 to respectively extend through the through holes 111 and respectively tap their own holes into the cabinet body 12 so that the fixed rail 11 is fastened to the cabinet body 12. However, when the furniture installer drills the holes by the screws 13, drill dust is generated and then falls from the holes (see FIGS. 2 and 3). Referring to FIG. 2 again, one of the screws 13 that is on a left side of FIG. 2 is completely screwed into the cabinet body 12 while one of the screws 13 that is on a right side of FIG. 2 is not. Most of the drill dust falls on a bottom portion of the fixed rail 11, but drill dust may also fall on the moving rail 19 (not shown in FIGS. 2 and 3), the linkage rail 18 (not shown in FIGS. 2 and 3), or lubricants (not shown). The balls 171 of the ball bearings 17 may thus run the drill dust over when rolling. Consequently, the balls 171 may not roll smoothly, and the conventional slide rail device may not function properly.

To prevent the drill dust from falling on the conventional slide rail device, some manufacturers may drill a plurality of threaded holes in the cabinet body 12 beforehand (not shown), and then abut the fixed rail 11 against the cabinet body 12 and screw the screws 13 respectively through the through holes 111 into the threaded holes. A conventional drill dust collector disclosed in Taiwanese Invention Patent No. 1635919 is used to collect the drill dust. The conventional drill dust collector is a box body that is foldable and that has an accommodating space. The box body has a pouring hole and an adaptation hole that are spaced apart from each other and that are in spatial communication with the accommodating space. Specifically, the pouring hole and the adaptation hole are located at two opposite sides of the box body. When the conventional drill dust collector is in use, one of the opposite sides of the box body at which the pouring hole is located is attached to the cabinet body 12, and an electric drill is inserted through the adaptation hole, the accommodating space, and the pouring hole sequentially so that the electric drill may drill a threaded hole in the cabinet body 12. At this time, the drill dust falls into the accommodating space through the pouring hole. The cabinet body 12 may be drilled to form a plurality of threaded holes. When the drilling is completed, the conventional drill dust collector is removed from the cabinet body 12, and then the fixed rail 11 is fastened to the cabinet body 12 by the screws 13. Although the drill dust may not affect the conventional slide rail device and may be collected by the abovementioned process, an additional step of drilling the threaded holes is needed, and the through holes 111 need to respectively align with the threaded holes so that the screws 13 may respectively be screwed into the threaded holes through the through holes 111. Thus, it is more difficult to manufacture and assemble.

### SUMMARY

Therefore, an object of the disclosure is to provide a slide rail device that can alleviate at least one of the drawbacks of the prior art.

According to the disclosure, the slide rail device is adapted for collecting drill dust, and includes a fixed rail, a moving rail, and a plurality of dust-collecting units. The fixed rail has a first surface and a second surface that are spaced apart from each other, a plurality of through holes that are formed through the first surface and the second surface, and a plurality of through-hole surfaces that respectively define the through holes. Each of the through-hole surfaces interconnects the first surface and the second surface, and defines two openings that are respectively in the first surface and the second surface. The moving rail is operable to slide relative to the fixed rail. The dust-collecting units are spaced apart from each other and are disposed on the fixed rail. Each of the dust-collecting units includes a cover member that closes one of the openings of a respective one of the through-hole surfaces, and a dust-catching member that is adapted for the drill dust to adhere thereto. The cover member of each of the dust-collecting units cooperates with the respective one of the through-hole surfaces to define a dust-collecting space.

### BRIEF DESCRIPTION OF THE DRAWINGS

Other features and advantages of the disclosure will become apparent in the following detailed description of the embodiment(s) with reference to the accompanying drawings. It is noted that various features may not be drawn to scale.

FIG. 1 is an exploded side view of a conventional slide rail device.

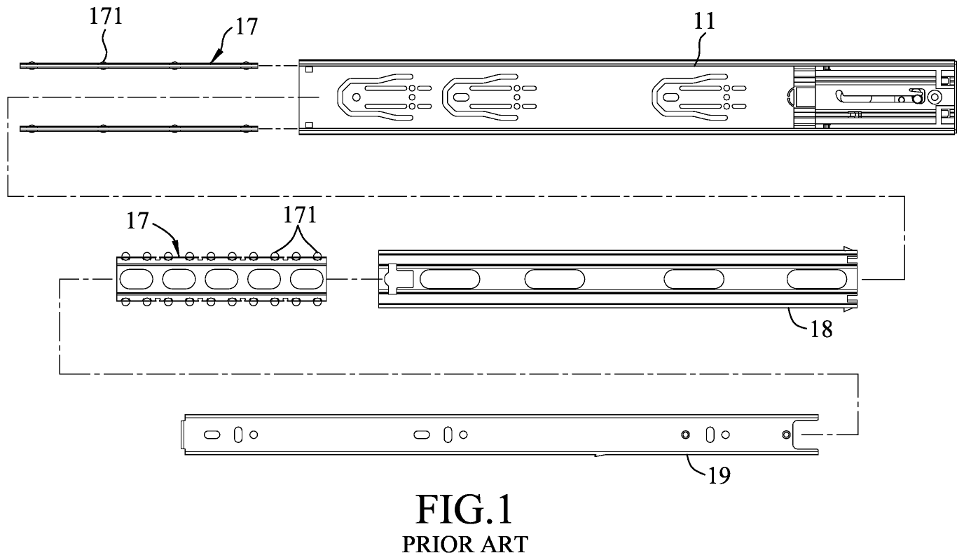

FIG. 2 is a fragmentary cutaway view illustrating how a fixed rail of the conventional slide rail device is fixedly mounted to a cabinet.

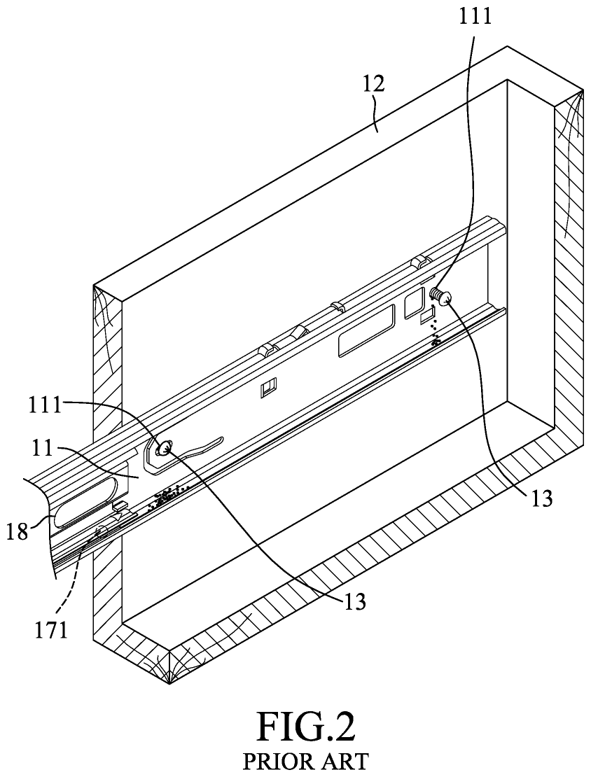

FIG. 3 is a fragmentary cutaway view illustrating a ball of a ball bearing of the conventional slide rail device running over drill dust.

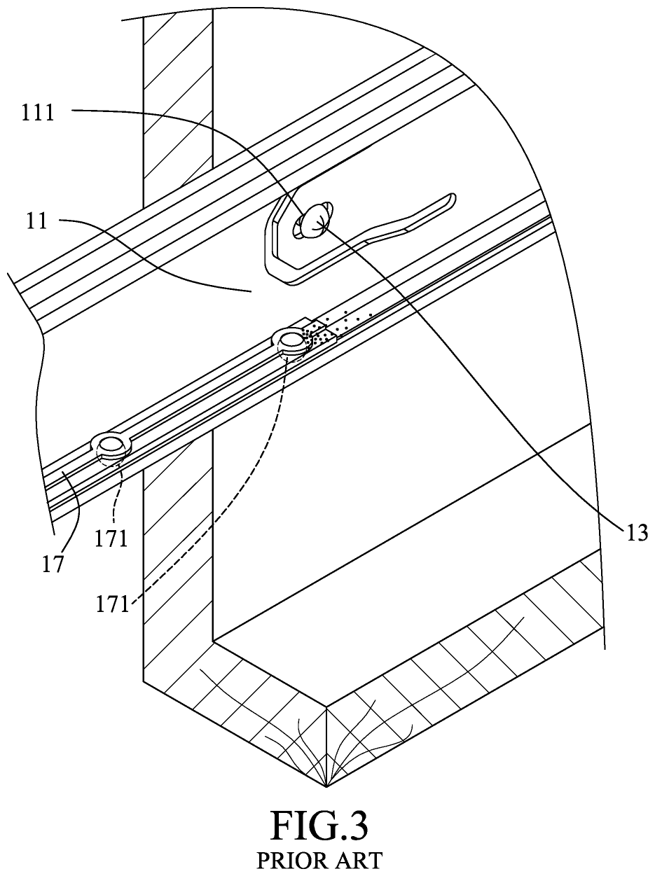

FIG. 4 is a perspective view illustrating a first embodiment of a slide rail device according to the disclosure.

FIG. 5 is a fragmentary cutaway view illustrating how a fixed rail of the first embodiment is fixedly mounted to a cabinet.

FIG. 6 is a fragmentary sectional view illustrating a dust-collecting unit of the first embodiment disposed on the fixed rail.

FIG. 7 is an enlarged, fragmentary cutaway view illustrating the first embodiment penetrated by a screw.

FIG. 8 is a schematic view illustrating the screw extending through the dust-collecting unit and the fixed rail into the cabinet.

FIG. 9 is a fragmentary sectional view illustrating a dust-collecting unit of a second embodiment of the slide rail device disposed on a fixed rail of the second embodiment.

FIG. 10 is a fragmentary sectional view illustrating a dust-collecting unit of a third embodiment of the slide rail device disposed on a fixed rail of the third embodiment.

FIG. 11 is a fragmentary sectional view illustrating a dust-collecting unit of a fourth embodiment of the slide rail device disposed on a fixed rail of the fourth embodiment.

FIG. 12 is a fragmentary sectional view illustrating a dust-collecting unit of a fifth embodiment of the slide rail device disposed on a fixed rail of the fifth embodiment.

FIG. 13 is a fragmentary sectional view illustrating a dust-collecting unit of a sixth embodiment of the slide rail device disposed on a fixed rail of the sixth embodiment.

### DETAILED DESCRIPTION

Before the disclosure is described in greater detail, it should be noted that where considered appropriate, reference numerals or terminal portions of reference numerals have been repeated among the figures to indicate corresponding or analogous elements, which may optionally have similar characteristics.

It should be noted herein that for clarity of description, spatially relative terms such as “top,” “bottom,” “upper,” “lower,” “on,” “above,” “over,” “downwardly,” “upwardly” and the like may be used throughout the disclosure while making reference to the features as illustrated in the drawings. The features may be oriented differently (e.g., rotated 90 degrees or at other orientations) and the spatially relative terms used herein may be interpreted accordingly.

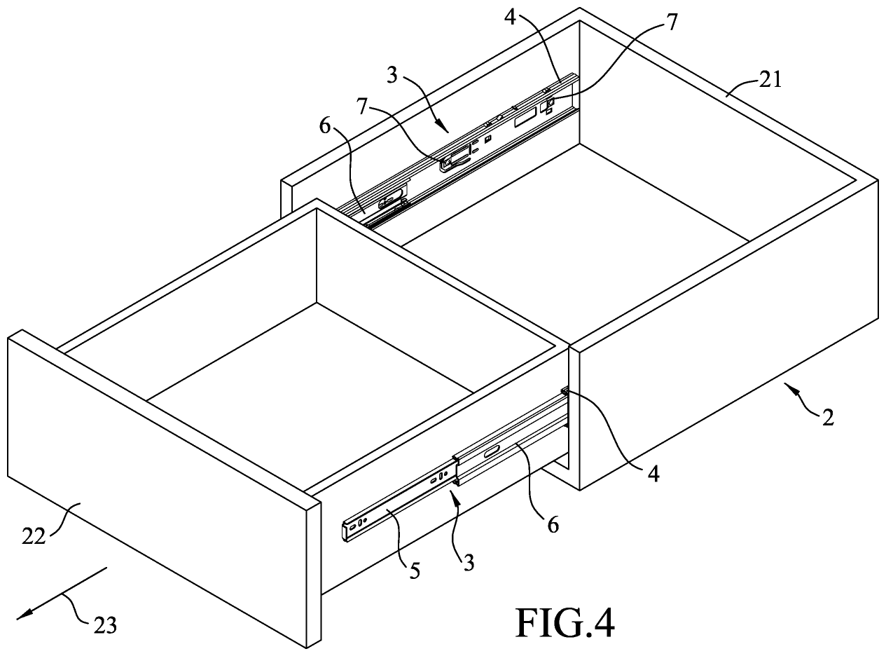

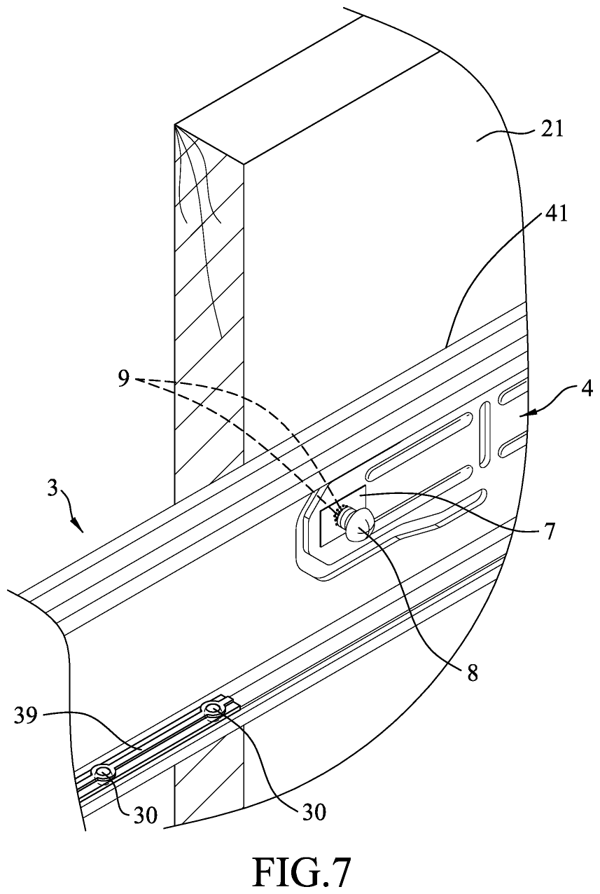

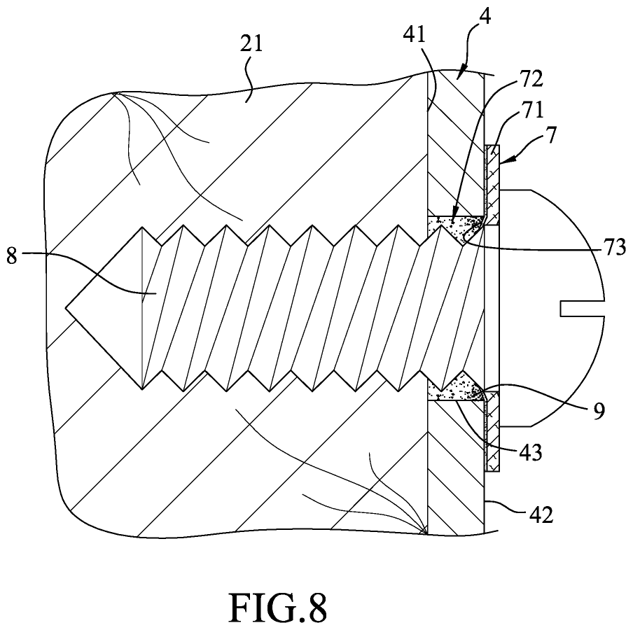

Referring to FIGS. 4 to 6, a first embodiment of a slide rail device 3 according to the disclosure is adapted to be mounted to a cabinet 2. The cabinet 2 includes a hollow cabinet body 21 and a drawer 22 that is movably disposed on the cabinet body 21. The slide rail device 3 is disposed between the cabinet body 21 and the drawer 22 so that the drawer 22 is operable to slide smoothly into or out of the cabinet body 21 in a sliding direction 23 to convert between an open state and a closed state. In FIG. 4, the drawer 22 is connected to the cabinet body 21 by two slide rail devices 3 that are located at two opposite sides of the drawer 22. It is noted that, the slide rail device 3 may be used on other objects, such as, but not limited to, a door panel, a window, and furniture. The slide rail device 3 is adapted for collecting drill dust 9 (see FIG. 8), and includes a fixed rail 4, a moving rail 5 that is operable to slide relative to the fixed rail 4, a linkage rail 6 that is slidably disposed between the fixed rail 4 and the moving rail 5, a plurality of dust-collecting units 7, and a plurality of ball bearings 39 (see FIG. 7, only one is shown) that are disposed among the fixed rail 4, the linkage rail 6, and the moving rail 5. Each of the ball bearings 39 includes a plurality of steel balls 30 for facilitating smooth sliding movement among the fixed rail 4, the linkage rail 6, and the moving rail 5.

The fixed rail 4 has a first surface 41, a second surface 42, a plurality of through holes 40 (only one is shown), and a plurality of through-hole surfaces 43 (only one is shown). The first and second surfaces 41, 42 are spaced apart from each other. The through holes 40 are formed through the first and second surfaces 41, 42. The through-hole surfaces 43 respectively define the through holes 40. Each of the through-hole surfaces 43 interconnects the first and second surfaces 41, 42, and defines two openings that are respectively in the first and second surfaces 41, 42. In the first embodiment, the first surface 41 abuts against the cabinet body 21, and the second surface 42 is adjacent to the linkage rail 6, but in certain embodiments, positional arrangement of the first and second surfaces 41, 42 may not be limited to that in the first embodiment, and may be changed.

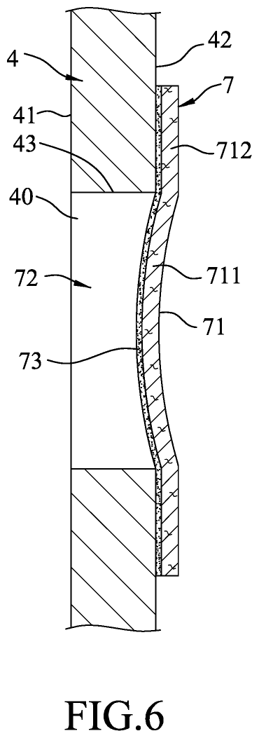

The dust-collecting units 7 are spaced apart from each other and are disposed on the second surface 42 of the fixed rail 4. Each of the dust-collecting units 7 includes a cover member 71 that closes one of the openings of a respective one of the through-hole surfaces 43, and a dust-catching member 73 that is adapted for the drill dust 9 to adhere thereto (see FIG. 8). In the first embodiment, the cover members 71 of the dust-collecting units 7 respectively close the openings of the through-hole surfaces 43 that are in the second surface 42. The cover member 71 of each of the dust-collecting units 7 cooperates with the respective one of the through-hole surfaces 43 to define a dust-collecting space 72 that opens in the first surface 41. The cover member 71 of each of the dust-collecting units 7 has a cover portion 711 that covers the one of the openings of the respective one of through-hole surfaces 43, and a connecting portion 712 that is integrated with the cover portion 711, that extends from a periphery of the cover portion 711, and that smoothly sticks to the second surface 42. In the first embodiment, the cover portion 711 of each of the dust-collecting units 7 is recessed from an imaginary plane defined by the connecting portion 712 of the dust-collecting unit 7, and extends into a respective one of the through holes 40 (see FIG. 6) so that each of the cover portions 711 of the dust-collecting units 7 serves as a mark that represents location of the respective one of the dust-collecting spaces 72. Consequently, it may help a furniture installer to drill holes accurately. Referring to FIG. 6 again, in the first embodiment, for each of the dust-collecting unit 7, the dust-catching member 73 is located between the cover member 71 and the dust-collecting space 72 defined by the cover member 71, and is an adhesive that is disposed on the cover member 71.

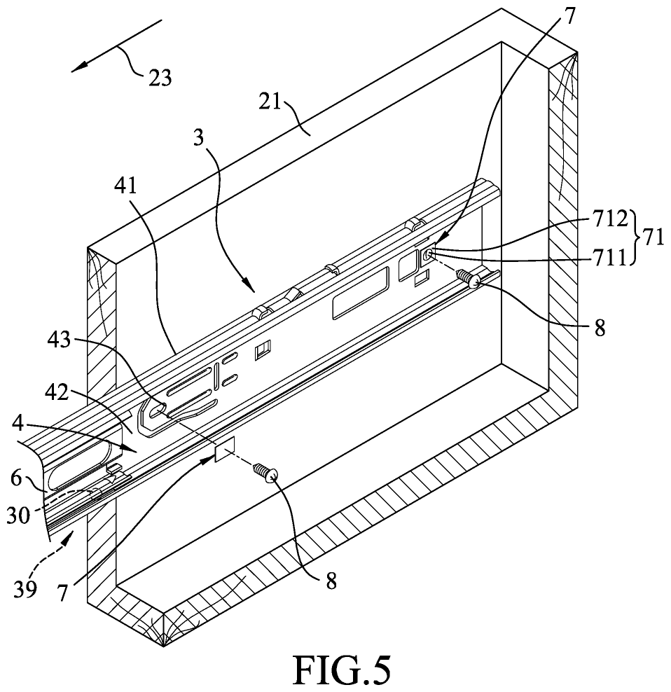

Referring to FIGS. 5, 7 and 8 again, when the furniture installer assembles the slide rail device 3 and the cabinet 2, the first surface 41 of the fixed rail 4 is urged to abut against the cabinet body 21. Then, the furniture installer may use a screwdriver or an electric screwdriver (not shown) to urge a plurality of screws 8 to respectively extend through the cover portions 711 of the dust-collecting units 7 and respectively tap their own holes into the cabinet body 21 so that the fixed rail 4 is fastened to the cabinet body 21. It may be relatively simple to manufacture the cabinet 2 because there is no need to drill a plurality of threaded holes in the cabinet body 21 in advance. Because the screws 8 respectively extend through the cover portions 711, the holes drilled by the furniture installer are respectively aligned with the through holes 4 and are respectively aligned with the dust-collecting spaces 72. When the furniture installer drills the holes in the cabinet 2 using the screws 8, the drill dust 9 is generated in each of the holes. The drill dust 9 in each of the holes is blocked by the respective one of the dust-collecting units 7 (i.e., the drill dust 9 is refrained from falling from the holes by the dust-collecting units 7). Specifically, the drill dust 9 in each of the holes is accommodated in the dust-collecting space 72 of the respective one of the dust-collecting units 7, and may adhere to the dust-catching member 73 of the dust-collecting unit 7 so that the drill dust 9 is refrained from falling on the fixed rail 4 from the holes. Therefore, the steel balls 30 of the ball bearings 39 may roll smoothly relative to the fixed rail 4, and the slide rail device 3 may function properly (i.e., sliding function of the slide rail device 3 may not be affected).

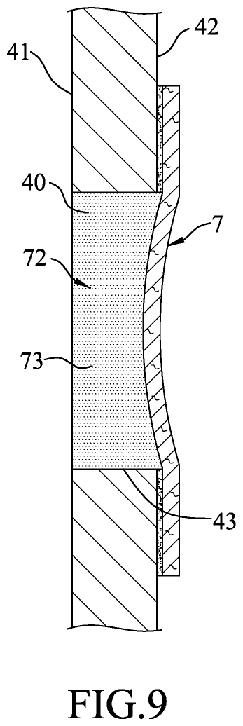

Referring to FIG. 9, a second embodiment of the slide rail device 3 according to the disclosure is generally similar to the first embodiment except that, in the second embodiment, the dust-catching member 73 of each of the dust-collecting units 7 is solid oil and is filled in the dust-collecting space 72 defined by the dust-collecting unit 7. The solid oil is used for the drill dust 9 (not shown in FIG. 9) to adhere thereto so that the drill dust 9 in each of the holes is refrained from leaving the dust-collecting space 72 of each of the dust-collecting units 7.

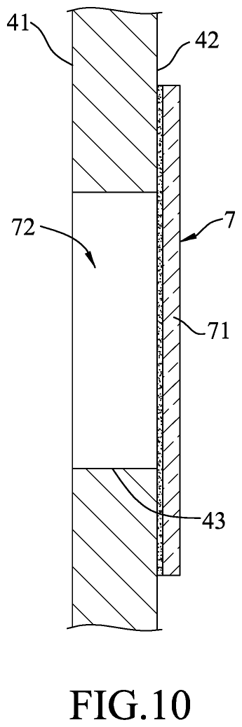

Referring to FIG. 10, a third embodiment of the slide rail device 3 according to the disclosure is generally similar to the first embodiment, except that, in the third embodiment, the cover member 71 of each of the dust-collecting units 7 is made of a transparent material so that the furniture installer may see the dust-collecting spaces 72 clearly when drilling holes. By virtue of the cover members 71 being transparent, each of the cover members 71 may be a flat sheet (i.e., each of the cover members 71 is configured not to partially extend into the respective one of the through holes 40), which may provide a larger dust-collecting space. In addition, since the furniture installer may see through the cover members 71, the furniture installer may easily drill the holes without marks (i.e., the recessed cover portions 711 in the first embodiment) that respectively represent the locations of the dust-collecting spaces 72.

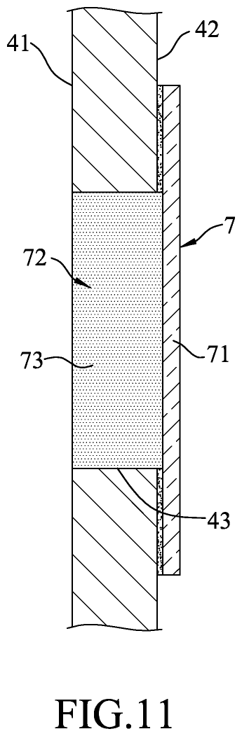

Referring to FIG. 11, a fourth embodiment of the slide rail device 3 according to the disclosure is generally similar to the second embodiment, except that, in the fourth embodiment, the cover member 71 of each of the dust-collecting units 7 is made of a transparent material so that the furniture installer may see the dust-collecting spaces 72 clearly when drilling holes. By virtue of the cover members 71 being transparent, each of the cover members 71 may be a flat sheet (i.e., each of the cover members 71 is configured not to partially extend into the respective one of the through holes 40), which may provide a larger dust-collecting space. In addition, since the furniture installer may see through the cover members 71, the furniture installer may easily drill the holes without the marks that respectively represent the locations of the dust-collecting spaces 72. In this embodiment, the dust-catching member 73 of each of the dust-collecting units 7 is solid oil and is filled in the dust-collecting space 72 defined by the dust-collecting unit 7.

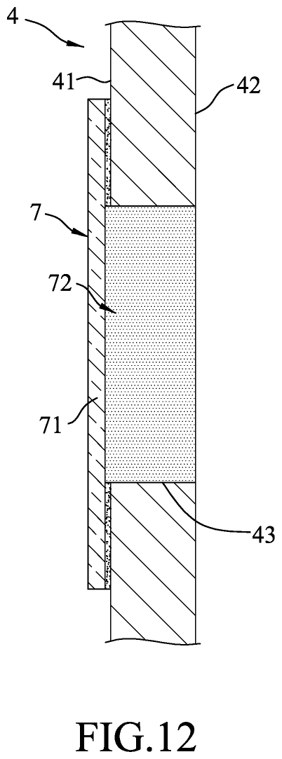

Referring to FIG. 12, a fifth embodiment of the slide rail device 3 according to the disclosure is generally similar to the fourth embodiment, except that, in the fifth embodiment, the dust-collecting units 7 are disposed on the first surface 41 of the fixed rail 4. Specifically, the cover members 71 stick to the first surface 41, and the cover member 71 of each of the dust-collecting units 7 closes the other one of the openings of the respective one of the through-hole surfaces 43 such that the dust-collecting spaces 72 open in the second surface 42. It is noted that, in each of the first, second, third, and fourth embodiments, the cover members 71 may stick to the first surface 41 of the fixed rail 4, and a detailed description thereof is omitted herein. No matter which one of the first and second surfaces 41, 42 that the cover members 71 stick to, the cover member 71 of each of the dust-collecting units 7 cooperates with the respective one of the through-hole surfaces 43 to define the dust-collecting space 72. In this embodiment, the dust-catching member 73 of each of the dust-collecting units 7 is solid oil and is filled in the dust-collecting space 72 defined by the dust-collecting unit 7.

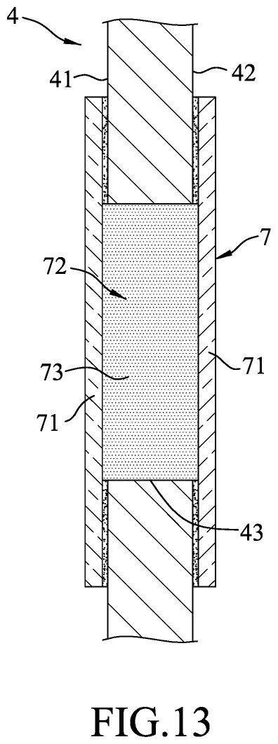

Referring to FIG. 13, a sixth embodiment of the slide rail device 3 according to the disclosure is generally similar to the fourth embodiment, except that, in the sixth embodiment, each of the dust-collecting units 7 includes two cover members 71 that respectively stick to the first and second surfaces 41, 42, and that respectively close the openings of the respective one of the through-hole surfaces 43. The cover members 71 of each of the dust-collecting units 7 cooperate with the respective one of the through-hole surfaces 43 to define the dust-collecting space 72. It is noted that, in each of the first, second, and third embodiments, each of the dust-collecting units 7 may include two cover members 71 that respectively stick to the first and second surfaces 41, 42 as in the sixth embodiment, and a detailed description thereof is omitted herein. In this embodiment, the dust-catching member 73 of each of the dust-collecting units 7 is solid oil and is filled in the dust-collecting space 72 defined by the dust-collecting unit 7.

In summary, by virtue of the cover member 71 of each of the dust-collecting units 7 closing the one of the openings of the respective one of the through-hole surfaces 43, and by virtue of the cover member 71 of each of the dust-collecting units 7 cooperating with the respective one of the through-hole surfaces 43 to define the dust-collecting space 72, the drill dust 9 generated in each of the holes may be prevented from falling on the fixed rail 4. Consequently, the sliding function of the slide rail device 3 may not be affected, which may improve quality of the slide rail device 3. The purpose of the disclosure is thus achieved.

In the description above, for the purposes of explanation, numerous specific details have been set forth in order to provide a thorough understanding of the embodiment(s). It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects; such does not mean that every one of these features needs to be practiced with the presence of all the other features. In other words, in any described embodiment, when implementation of one or more features or specific details does not affect implementation of another one or more features or specific details, said one or more features may be singled out and practiced alone without said another one or more features or specific details. It should be further noted that one or more features or specific details from one embodiment may be practiced together with one or more features or specific details from another embodiment, where appropriate, in the practice of the disclosure.

While the disclosure has been described in connection with what is(are) considered the exemplary embodiment(s), it is understood that this disclosure is not limited to the disclosed embodiment(s) but is intended to cover various arrangements included within the spirit and scope of the broadest interpretation so as to encompass all such modifications and equivalent arrangements.

What is claimed is:

1. A slide rail device adapted for collecting drill dust, the slide rail device comprising:
a fixed rail having a first surface and a second surface that are spaced apart from each other, a plurality of through holes that are formed through the first surface and the second surface, and a plurality of through-hole surfaces that respectively define the through holes, each of the through-hole surfaces interconnecting the first surface and the second surface, and defining two openings that are respectively in the first surface and the second surface;
a moving rail operable to slide relative to the fixed rail; and
a plurality of dust-collecting units spaced apart from each other and disposed on the fixed rail, each of the dust-collecting units including a cover member that closes one of the openings of a respective one of the through-hole surfaces, and a dust-catching member that is adapted for the drill dust to adhere thereto, the cover member of each of the dust-collecting units cooperating with the respective one of the through-hole surfaces to define a dust-collecting space.

2. The slide rail device as claimed in claim 1, wherein the dust-catching member of each of the dust-collecting units is an adhesive that is disposed on the cover member of the dust-collecting unit.

3. The slide rail device as claimed in claim 1, wherein the dust-catching member of each of the dust-collecting units is solid oil and is filled in the dust-collecting space defined by the dust-collecting unit.
